(19) United States
(12) Patent Application Publication
(10) Pub. No.: US 2015/0049194 A1
(43) Pub. Date: Feb. 19, 2015

(54) VEHICLE BLACK BOX

(71) Applicant: FIH (Hong Kong) Limited, Kowloon (HK)

(72) Inventor: JER-SHENG LEE, New Taipei (TW)

(73) Assignee: FIH (HONG KONG) LIMITED, Kowloon (HK)

(21) Appl. No.: 14/185,929

(22) Filed: Feb. 21, 2014

(30) Foreign Application Priority Data
Aug. 16, 2013 (CN) 2013103573852

(51) Int. Cl. H04N 7/18; H04N 5/232; H04N 5/225

(52) U.S. Cl. CPC H04N 7/183; H04N 5/2252; H04N 5/2254; H04N 5/23296
USPC 348/148

(57) ABSTRACT

A vehicle black box used for obtaining videos includes a housing, a circuit board, a camera having a lens, a cover, and a zoom lens. The camera is positioned on and electrically connected to the circuit board. The circuit board is received in the housing. The cover is latched to the housing. The zoom lens is electrically connected to the circuit board, fixed to the cover, and aligns with the lens of the camera. The zoom lens and the camera cooperatively obtain the videos.

### FIELD

The disclosure generally relates to vehicle black boxes, and particularly to a vehicle black box for recording videos with clear images.

### BACKGROUND

Vehicle black boxes can record videos of the outside surroundings of the vehicle while the vehicle is driven. However, to obtain videos with clear images, most vehicle black boxes employ HD cameras or image sensing microchips, which increase the cost of the vehicle black boxes. Furthermore, videos obtained by HD cameras occupy a large amount of memory space of the vehicle black boxes.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is an exploded view of an embodiment of a vehicle black box.

FIG. 2 is similar to FIG. 1, but shown from another aspect.

FIG. 3 is an assembled view of the vehicle black box of FIG. 1.

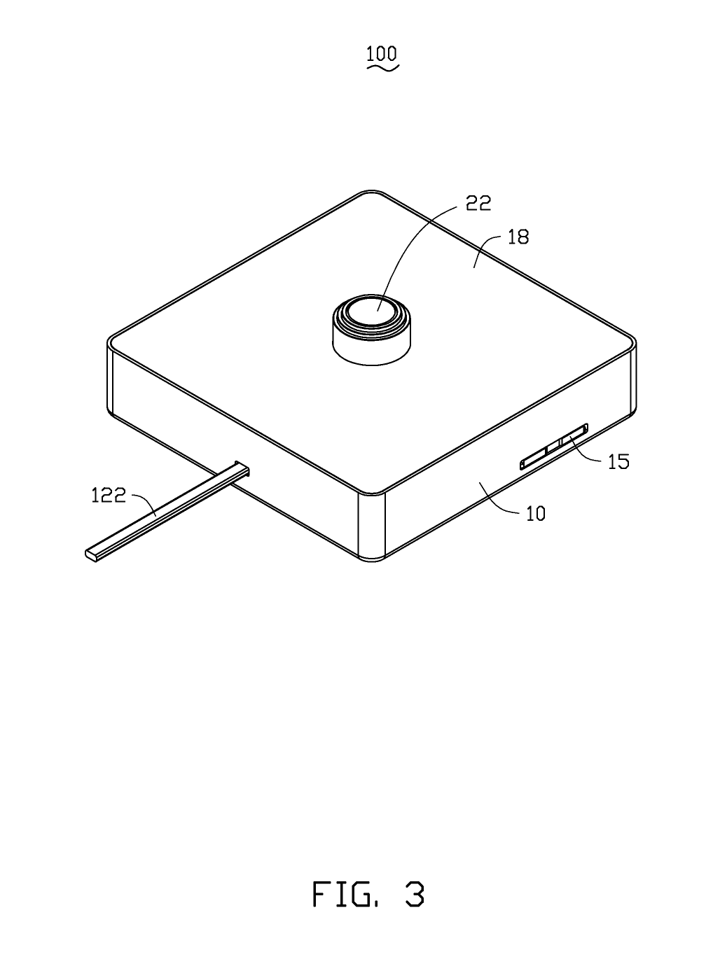

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

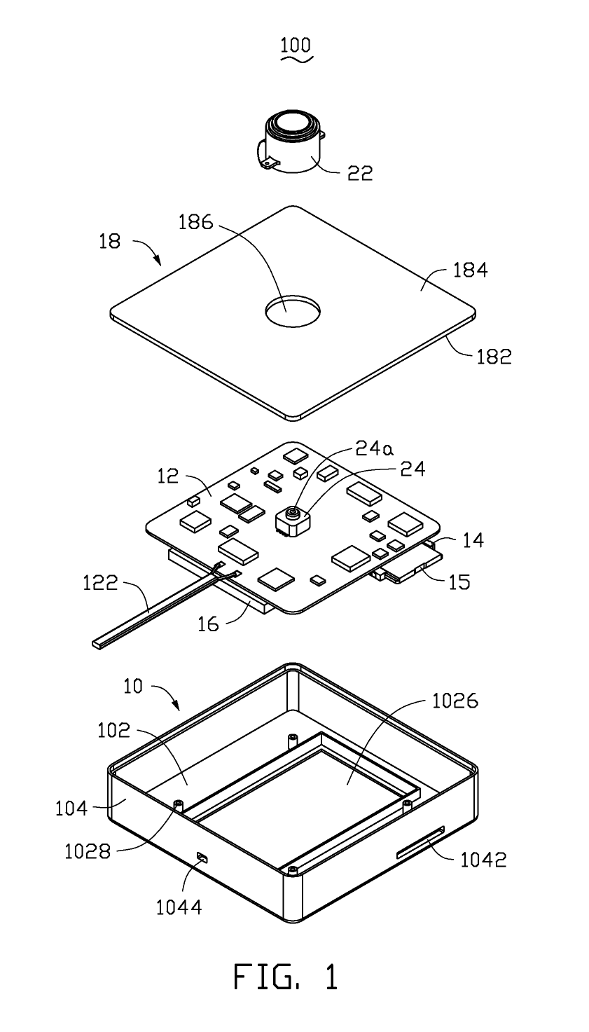

FIG. 1 is an exploded view of a vehicle black box 100. The vehicle black box 100 includes a housing 10, a circuit board 12, a connector 14, a memory storage card 15, an optional display 16, a cover 18, a zoom lens 22, and a camera 24 having a lens 24a.

The circuit board 12 is received in the housing 10. The connector 14 for receiving the memory storage card 15, and the camera 24 are located on and electrically connected to the circuit board 12. The memory storage card 15 is received in the connector 14. The zoom lens 22 is assembled to the cover 18 and coupled to the camera 24 to obtain videos. The cover 18 covers the housing 10.

In this embodiment, the housing 10 is an outer shell of the vehicle black box 100 configured to receive inner components (e.g., the circuit board 12) of the vehicle black box 100. The housing 10 includes a bottom wall 102 and multiple (e.g., four) surface walls 104 connected substantially perpendicularly to the bottom wall 102. An opening 1026 is defined in the bottom wall 102. Supporting posts 1028 protrude from the bottom wall 102 adjacent to the opening 1026 to support the circuit board 12. A slot 1042 is defined in one of the surface walls 104. A hole 1044 is defined in another one of the surface walls 104.

The circuit board 12 is configured to assemble various electronic elements such as a processor of the vehicle black box 100. In this embodiment, the camera 24 is located on a first surface of the circuit board 12. The connector 14 and the optional display 16 are located on a second surface of the circuit board 12. The connector 14 and the camera 24 is assembled to the circuit board 12 by surface-mount technology (SMT) and, as previously mentioned, electronically connected to the circuit board 12. When the circuit board 12 is received in the housing 10, the circuit board 12 is supported by the supporting posts 1028. The connector 14 aligns with the slot 1042 to receive the memory storage card 15 through the slot 1042. A power line 122 is received through the hole 1044 to connect a power supply (not shown) to the circuit board 12. When present, the optional display 16 is exposed through the opening 1026 to display video.

In one embodiment, the cover 18 is a substantially rectangular planar board. The cover 18 includes a first surface 182 and a second surface 184 opposite from the first surface 182. A mounting hole 186 is defined in a substantially central portion of the cover 18. Two protruding posts 188 protrude from the first surface 182. The mounting hole 186 and the protruding posts 188 are configured to assemble the zoom lens 22.

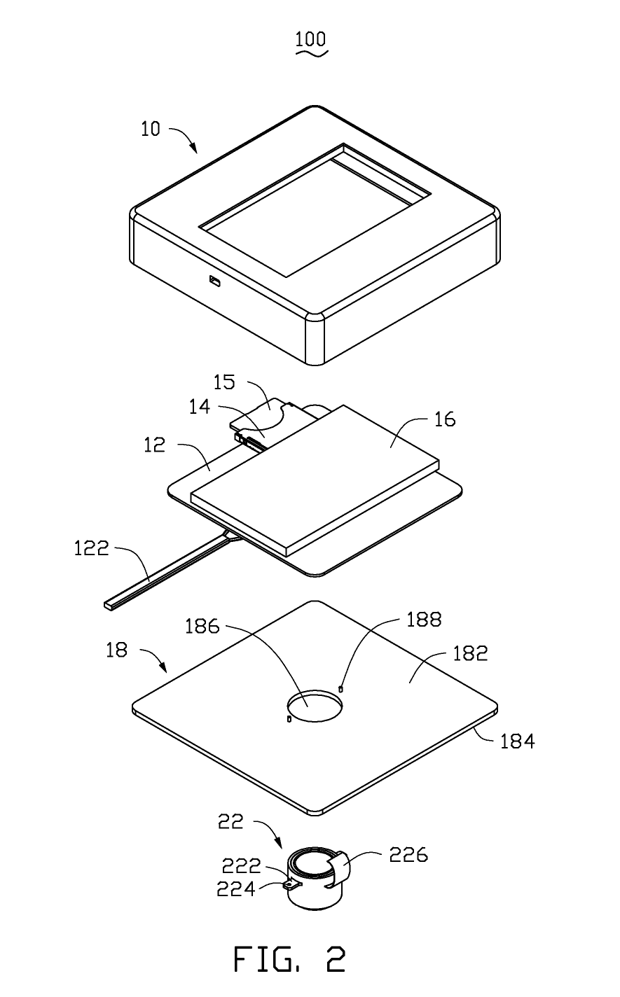

The zoom lens 22 and the camera 24 are configured to cooperatively obtain the videos and transmit the videos to the optional display 16 when present. The zoom lens 22 includes two opposite latching portions 222, and a flexible circuit board 226 (shown in FIG. 2) electrically connected to the zoom lens 22. Each latching portion 222 defines a positioning hole 224 corresponding to one of the protruding posts 188. The flexible circuit board 226 is configured to electronically connect to the circuit board 12.

The camera 24 is located in a substantially central portion of the circuit board 12 and electronically connected to the circuit board 12. When the circuit board 12 is assembled in the housing 10, the lens 24a of the camera 24 aligns with the zoom lens 22.

In assembly, the circuit board 12 is received in the housing 10 and positioned on the supporting posts 1028. The optional display 16 and the connector 14 are exposed through the opening 1026 and the slot 1042, respectively. The power line 122 is received through the hole 1044 and electrically connected to the circuit board 12. The memory storage card 15 is inserted into the connector 14. The zoom lens 22 is received through the mounting hole 186. The protruding posts 188 are received through the positioning holes 224 to fix the zoom lens 22 to the cover 18. The flexible circuit board 226 is electronically connected to the circuit board 12. The cover 18 is covered on the housing 10, such that the zoom lens 22 aligns with the lens 24a of camera 24.

In use, the vehicle black box 100 is assembled to a vehicle (not shown). The power line 122 is electronically connected to a power supply (not shown) of the vehicle so that the vehicle black box 100 is powered on when the vehicle is powered on. The zoom lens 22 faces the outside surroundings of the vehicle. When other vehicles enter within a preset (as stored in the processor of the black box) distance of the vehicle, the zoom lens 22 is sent a signal from the processor to lock onto the other vehicles and adjust its focus so that the camera 24 obtains clear video images (e.g., images showing a license plate number of the other vehicles). The obtained videos can be displayed by the optional display 16 and stored in the memory storage card 15.

The vehicle black box 100 uses the zoom lens 22 with the lens 24a of camera 24 to obtain clear video images. Thus, an HD camera and an image sensing microchip are not needed, thus reducing a cost of the vehicle black box 100. Furthermore, the images obtained by the camera 24 take up less memory space than images obtained by the HD camera.

The exemplary embodiments and their advantages will be understood from the foregoing description, and it will be apparent that various changes may be made thereto without departing from the spirit and scope of the disclosure or sacrificing its material advantages, the examples hereinbefore described merely being preferred or exemplary embodiments of the disclosure.

What is claimed is:

1. A vehicle black box configured for obtaining videos during use of the vehicle, the vehicle black box comprising:
a housing;
a circuit board received in the housing;
a camera having a lens, the camera positioned on and electrically connected to the circuit board;
a cover latched to the housing; and
a zoom lens electrically connected to the circuit board, fixed to the cover, and aligning with the lens of the camera, wherein the zoom lens and the camera cooperatively obtain the videos.

2. The vehicle black box of claim 1, wherein the cover defines a mounting hole, and the zoom lens is received in the mounting hole.

3. The vehicle black box of claim 1, wherein the zoom lens comprises at least one latching portion at an end of the zoom lens, the latching portion defining a positioning hole, the cover comprises protruding posts corresponding to the latching portions and positioned adjacent the mounting hole, each protruding post engaging a corresponding positioning hole.

4. The vehicle black box of claim 1, further comprising a display positioned on the circuit board for displaying the videos.

5. The vehicle black box of claim 4, wherein the housing comprises a bottom wall and surface walls perpendicularly extending from a peripheral edge of the bottom wall, the bottom wall defines an opening, the display exposed through the opening.

6. The vehicle black box of claim 1, further comprising a connector electrically connected to the circuit board and a memory storage card inserted into the connector, the memory storage card stores the videos.

7. The vehicle black box of claim 6, wherein one of the surface walls defines a slot, the connector is exposed through the slot.

8. The vehicle black box of claim 6, wherein the housing comprises a plurality of supporting posts protruding from the bottom wall; the circuit board is supported by the supporting posts.

9. A vehicle black box configured for obtaining videos during use of the vehicle, the vehicle black box comprising:
a housing;
a circuit board received in the housing;
a camera having a lens positioned on the circuit board and electrically connected to obtain the videos;
a cover latched to the housing; and
a zoom lens electrically connected to the circuit board fixed to the cover, and aligning with the lens of the camera; wherein the zoom lens automatically adjusts focus for the camera.

10. The vehicle black box of claim 9, wherein the cover defines a mounting hole, the zoom lens is received in the mounting hole.

11. The vehicle black box of claim 9, wherein the zoom lens comprises at least one latching portion at an end of the zoom lens, the latching portion defining a positioning hole, the cover comprises protruding posts corresponding to the latching portions and positioned adjacent the mounting hole, each protruding post engaging a corresponding positioning hole.

12. The vehicle black box of claim 9, further comprising a 1 display position on the circuit board for displaying the videos.

13. The vehicle black box of claim 12, wherein the housing comprises a bottom wall and surface walls perpendicularly extending from a peripheral edge of the bottom wall, the bottom wall defines an opening, the display is exposed through the opening.

14. The vehicle black box of claim 9, further comprising a connector electrically connected to the circuit board and a memory storage card inserted into the connector, the memory storage card stores the videos.

15. The vehicle black box of claim 13, wherein one of the surface walls defines a slot, the connector is exposed through the slot.

16. The vehicle black box of claim 13, wherein the housing comprises a plurality of supporting posts protruding from the bottom wall; the circuit board is supported by the supporting posts.
